(19) United States
(12) Patent Application Publication
(10) Pub. No.: US 2009/0075004 A1
(43) Pub. Date: Mar. 19, 2009

(54) APPARATUS AND METHODS FOR CROSS-LINKED CORRUGATED POLYETHYLENE PIPE

(75) Inventor: Joseph M. Starita, Marysville, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: ADVANCED DRAINAGE SYSTEMS, INC., Hilliard, OH (US)

(21) Appl. No.: 11/944,071

(22) Filed: Nov. 21, 2007

Related U.S. Application Data
(60) Provisional application No. 60/866,713, filed on Nov. 21, 2006.
(60) Provisional application No. 60/932,876, filed on Jun. 1, 2007.

(51) Int. Cl. C08L 23/06; B32B 1/08

(52) U.S. Cl. 428/36.91; 428/36.9; 524/587

(57) ABSTRACT

A composition and method for a single or dual wall extruded and thermoformed pipe corrugated HDPE pipe composed of a thermoplastic HDPE that is subsequently cross-linked by introducing moisture. The typical thermoplastic HDPE utilized for blow molding to fabricate the corrugated pipe is cross-linked to enhance dimensional stability, stress crack resistance, impact, creep resistance, and stiffness. The method also may comprise obtaining the enhanced properties by cross-linking the already fabricated linear HDPE corrugated pipe. The cross-linked HDPE is produced using a silane processing method. A composition may comprise a high density polyethylene compound composed with about 1 to 15 percent of finely ground isotropic cross-linked polyethylene recycle.

### CROSS-REFERENCE TO RELATED APPLICATIONS

This application claims the benefit of U.S. Provisional Application No. 60/866,713 filed Nov. 21, 2006 and U.S. Provisional Application No. 60/932,876 filed Jun. 1, 2007, which are both herein incorporated by reference.

### FIELD OF THE INVENTION

The present invention generally relates to polyethylene pipe. More particularly, the present invention relates to apparatus, compositions, and methods for cross-linked polyethylene pipe such as, for example, cross-linked high density polyethylene corrugated pipe.

### BACKGROUND OF THE INVENTION

The single wall and dual wall corrugated polyethylene pipe industry is approximately $1.5 billion dollars annually and is utilized mainly for agricultural, parking lot, and highway drainage applications. In a few instances, corrugated polyethylene pipe is utilized for sanitary sewer applications.

### BRIEF DESCRIPTION OF THE FIGURES

The following detailed description of exemplary embodiments of the present invention can be best understood when read in conjunction with the following drawings, where like structure is indicated with like reference numerals and in which:

FIG. 1 is a cross section of an exemplary embodiment of a typical dual wall corrugated high density polyethylene pipe section according to the present invention; and

FIG. 2 is a cross section of an exemplary embodiment of a typical single wall corrugated high density polyethylene pipe section according to the present invention.

### DETAILED DESCRIPTION OF THE INVENTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

In an exemplary embodiment, the present invention comprises a cross-linked single and/or dual wall high density polyethylene (“HDPE”) corrugated pipe in which a curable HDPE tubular polymer extrudate called a parison is thermoformed into a corrugated shell before a post extrusion cross-linking step and methods for providing the same. In another exemplary embodiment of the present invention, a large diameter such as, for example, from about 10 inches to about 72 inches in diameter, cross linked, HDPE corrugated pipe is produced using one or more methods of the present invention. In another exemplary embodiment, the present invention provides apparatus and methods to fabricate corrugated cross-linked high density pipe from a relatively low cost and low performance grade of high density polyethylene resin. For example, the invention discloses a HDPE composition having a crack resistance from about 10 to about 5000 PENT hours F 1473 at about 2.4 MPa and about 80 C which results from cross-linking a thermoplastic HDPE having a value of stress crack resistance from about 1 to about 9 PENT hours F 1473 at 2.4 MPa and 80 C. Another exemplary embodiment of the present invention comprises cross-linked HDPE compounds comprising a content of recycled cross-linked HDPE and/or corrugated pipe formed from this cross-linked HDPE comprising the recycled cross-linked HDPE content. As such, the cross-linked HDPE comprising the recycled cross-linked HDPE and/or the cross-linked corrugated pipe formed from the same exhibit a stiffness that is about the same as a cross-linked HDPE that does not include recycle content material and/or cross-linked HDPE pipe that does not include recycle content, respectively.

Still another exemplary embodiment of the present invention comprises a cross-linked high density polyethylene corrugated pipe having significantly enhanced tensile, flexural, elongation, impact and stress crack resistance characteristics as compared to that of a conventional thermoplastic HDPE corrugated pipe. In this exemplary embodiment, the present invention provides the benefit of a cross-linked HDPE corrugated pipe that is stiffer than that of a conventional thermoplastic HDPE corrugated pipe providing improved installation, pressure bearing, deep burial and joint strength characteristics. Similarly, the cross-linked HDPE corrugated pipe of the present invention exhibits significantly longer service life due to enhanced stress crack resistance than that found in a conventional thermoplastic HDPE corrugated pipe. The tensile strength and impact of the cross-linked HDPE corrugated pipe of the present invention are also enhanced when compared with the tensile strength and impact of a conventional thermoplastic HDPE corrugated pipe.

In still yet another exemplary embodiment, the present invention comprises a HDPE resin having extrusion and thermoforming characteristic similar to or greater than that of the American Association of State Highway Transportation Officials (AASHTO) certified HDPE.

Exemplary apparatus and methods for cross-linked corrugated pipe of the present invention is described and shown in commonly assigned, co-pending provisional Application Ser. No. 60/866,713 filed on Nov. 21, 2006, which is herein incorporated by reference.

A typical comparison of properties between a conventional, linear HDPE corrugated pipe and a cross-linked HDPE corrugated pipe of the present invention is as follows:

ESCR Condition A ASTM D-1683 is generally greater than (>) about 1,000 hours for a cross-linked HDPE corrugated pipe of the present invention compared to less than (<) about 100 hours for a conventional, linear HDPE corrugated pipe.

Low temperature impact ARM-low Impact for about 3.175 mm (⅛ inch) specimen is about 102 joules (75 ft-lbs) for a cross-linked HDPE corrugated pipe of the present invention compared to about 95 joules (70 ft-lbs) for a conventional, linear HDPE corrugated pipe.

Polyethylene notch Test (PENT) ASTM F 1473 (about 80 degrees C., about 2.4 MPa) is greater than (>) about 1000 hours for a cross-linked HDPE corrugated pipe of the present invention compared to less than (<) about 10 hours for a conventional, linear HDPE corrugated pipe.

Long Term hydrostatic ((LTHS) (creep) at about 60 degrees C. (about 140 F.) is about 6.2 MPa (about 900 psi) for a cross-linked HDPE corrugated pipe of the present invention compared to less than (<) about 3.5 MPa (about 500 psi) for a conventional, linear HDPE corrugated pipe.

Another exemplary embodiment of the present invention discloses the apparatus (e.g., composition) and method of reintroducing finely ground recycled product as inert filler into the polymer melt forming process of both uncross-linked and cross-linkable polyethylene products. The finely ground cross-linked polyethylene recycle can be introduced to melt forming processes that include but are not limited to injection molding, transfer molding, compression molding and extrusion. The present invention discloses amounts and composition of isotropic (un-oriented) powder that result in physical properties which are approximately equal to the product without the recycled cross-linked polyethylene powder content.

The invention is described more fully in the following description of the preferred embodiment considered in view of the drawings in which the single and dual wall corrugated high density polyethylene pipe is represented.

In one exemplary embodiment of the present invention, the method may generally comprise mixing a commercially available polyethylene resin, catalyst, and curing agent, extruding this polyethylene compound to produce a product such as a straight pipe extrudate (i.e., melt parisons), thermoforming the extrudate into a thermoformed product such as a corrugated pipe, and then exposing the corrugated pipe to moisture to form the cross-linked network within the HDPE of the corrugated pipe, thus forming a cross-linked, HDPE corrugated pipe, shell or liner of the single and dual wall corrugated pipe of the present invention.

The first two steps of this process may comprise the Dow Corning Sioplas® process which includes two steps: one to produce a polyethylene compound composed of polyethylene, catalyst and curing agent; and a second one where this polyethylene compound is extruded to produce an extrudate. The extrudate produced from this process is then thermoformed into a corrugated pipe section. This avoids the safety problems associated with handling and metering the crosslinking agent. However this method is not as cost effective as the next exemplary embodiment because it requires 100 percent of the polyethylene to be pre-compounded and pelletized. An exemplary curing agent that may be used with the present invention comprises silane.

In another exemplary embodiment, a method may generally comprise mixing a master batch comprised of a polyethylene carrier, curing agent and catalyst, adding this master batch to a base polymer, extruding the mixture of the master batch and base polymer to form a straight pipe extrudate (i.e., melt parisons), thermoforming the straight pipe extrudate into a corrugated pipe, exposing the corrugated pipe extrudate to moisture to form a cross-linked network within the HDPE of the corrugated pipe, thus forming a cross-linked, HDPE corrugated pipe, shell, or liner of the single and dual wall corrugated pipe of the present invention. An exemplary curing agent that may be used with the present invention comprises silane.

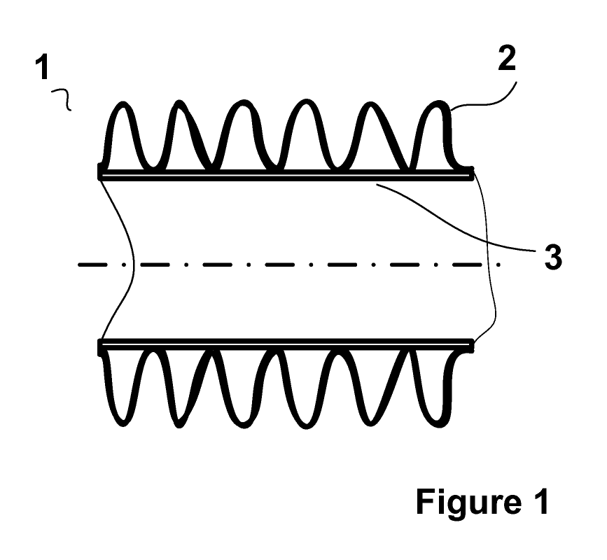

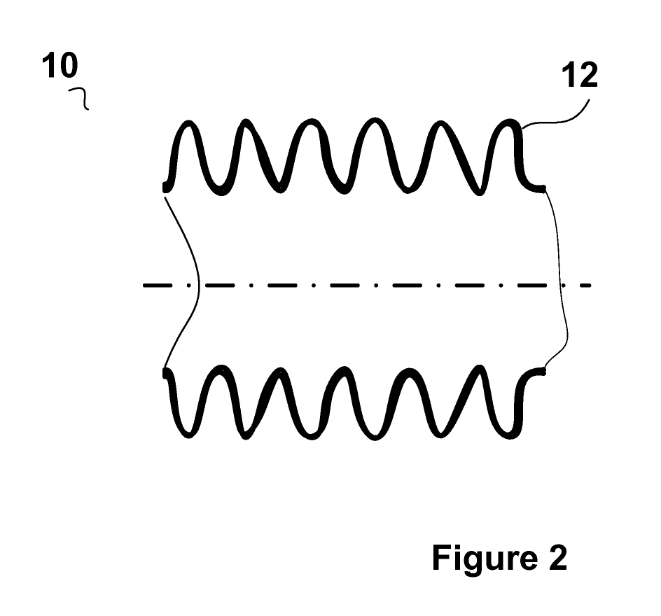

FIG. 1 shows a cross section of a dual wall corrugated high density polyethylene pipe 1 of the present invention with the outer corrugated shell 2 which is extruded first as a melt parison (tube) and then the corrugations are thermoformed typically with the aid of vacuum. The smooth liner 3 is extruded and sized in the melt. This invention refers to curable corrugated high density polyethylene pipe having at least a cross-linkable corrugated shell FIG. 2 shows a cross section of a single wall corrugated high density polyethylene pipe 10 having a corrugated shell 12 of the present invention which is also a product of a thermoformed extruded melt parison (tube).

The present invention facilitates the extrusion and thermoforming of cross-link curable melted high density polyethylene into single and dual wall corrugated pipe. The manufacturing process of extruding and thermoforming the cross-linkable polyethylene melt parisons is the same as for conventional thermoplastic high density polyethylene corrugated pipe. However, the exemplary method of the present invention comprises a moisture exposure step that occurs after the extrusion and thermoforming processes are completed. It has been discovered that placing a moisture exposure step after the thermoforming step enables a plastic product to still be thermoformed and cross-linked, thereby stabilizing the thermoformed structure which has not been accomplished before the present invention. The exposure of the thermoformed, corrugated pipe to moisture enables the formation of a cross-linked network in the thermoformed product (i.e., corrugated pipe). In other words, the shape of the thermoformed corrugated shell is stabilized and locked in place by the post thermoforming crosslinking process. Typically thermoformed corrugated shells retain residual stresses that affects shape, impact and strength of the polymer. This cross-linked property set of an extruded and thermoformed corrugated shell has not been accomplished previously.

In this exemplary embodiment, the master batch comprises mixing a silane curing agent (e.g. Dow Corning Z 6300 [tri-methoxy]]), catalyst, and HDPE, all of which are commercially available, compounding the mixture, and pelletizing the compound. In one exemplary embodiment, the precise amount of grafted silane is tightly regulated. The amount of master batch mixed with the thermoplastic HDPE resin is sufficient to affect a cure about 65 to about 80 gel preferably 70 percent gel. of the extruded, thermoformed and then cured corrugated pipe section. The let down ratio of base polymer to master batch is about 10 to 1 to about 50 to 1 preferably 25 to 1. For example the Dow Corning Monosil® process can be utilized to produce such a master batch. The master batch is then sealed and stored. The Dow Corning Sioplas® process may be used for and in conjunction with the present invention to produce melt parisons as set forth above.

In this exemplary embodiment, the master batch is then added to HDPE (i.e., base polymer), wherein the master batch and the base HDPE are extruded and thermoformed together into a single or dual wall corrugated pipe melt parison. Next, the melt parison is thermoformed into a corrugated shell of the single or dual wall corrugated pipe of the present invention. Finally, moisture is introduced or ambient humidity conditions are such that it provides the moisture required to cross-link the HDPE of the single or dual wall corrugated pipe. Depending on the temperature and moisture content a cure of greater than 70 percent gel is developed within a few hours or as long as a week. This results in cross-linked single and dual wall corrugated HDPE pipe with enhanced dimensional stability, stiffness, tensile strength, and creep resistance as compared to a conventional thermoplastic high density polyethylene corrugated pipe. Therefore the installation sensitivity, burial depth, joint strength and pressure rating specifications are improved.

In one exemplary embodiment, the present invention comprises fabricating a cross-linked HDPE corrugated pipe from linear HDPE in the conventional manner and subsequently cross-linking the linear HDPE to produce the cross-linked HDPE corrugated pipe of the present invention. In the manufacturing process of corrugated HDPE a tubular melt parison is thermoformed into a corrugated shell. This means that crosslinking systems that operate in the melt are not suitable to accommodate the thermoforming requirement. For example, peroxide curing agents are suitable extruding cross-linked solid wall polyethylene pipe but not for producing corrugated polyethylene pipe. The reason is based on the difficulty of thermoforming cross-linked polyethylene melt parisons.

In another exemplary embodiment, the present invention utilizes a base resin that is HDPE optimized for ease of extrusion and thermoforming processing. Additives such oxidative stabilizers, processing aids and colorants are added. In this embodiment, carbon black is used as a colorant in quantities from about 1 to about 6 percent (preferably from about 3 to about 5 percent). The extrusion and thermoforming occur prior to crosslinking. The cross-linking enhances the pipe performance properties resulting in a HDPE superior to highest performing Plastic Pipe Institute (PPI) certified PE-100 Hydrostatic Design Basis (HDB) polyethylene pressure pipe resin. The thermoplastic HDPE corrugated HDPE is typically compounded with process and thermal oxidative stabilizers to meet the standards set by Association of State Highway Transportation officials (AASHTO) for highway drainage applications. The present AASHTO M294 standard requires a HDPE having stress crack resistance that exceeds typical blow molding grades. The present invention discloses technology that enables the pipe manufacturer to exceed the ASSHTO M294 stress crack resistance standard with base polyethylene materials that do not.

This invention allows present manufacturers of thermoplastic corrugated polyethylene pipe to convert extrusion production capacity back and forth between cross-linked pipe and thermoplastic polyethylene pipe without significantly altering the existing process conditions and equipment. An example is extruding, thermoforming and cross-linking commercially available, commodity grades of thermoplastic HDPE resins having a melt index (MI) from about 0.1 to about 0.5 grams per about 10 minutes and specific gravity from about 0.947 to about 0.960. In another exemplary embodiment, the present invention utilizes 5202 grade (HDPE molding grade manufactured by a number of material suppliers) with a specific gravity of about 0.952 and melt index (MI) of about 0.25 grams per about 10 minutes.

Another embodiment uses another blow molding HDPE which is 5503 grade also offered by a number of material suppliers. These suppliers include but are not limited to Chevron Phillips and Equistar. 5502 has a specific gravity of about 0.955 and melt index (MI) of about 0.35 grams per 10 minute. The MI is measured according to the American Society of Testing Materials (ASTM) D1238 (2.1 kilograms at 190 C.) standard. The environment stress crack resistance is about 45 and about 35 hours for condition A and B respectively as per the ASTM D1293 standard. The tensile strength is about 4,000 psi (27 MPa), about 600% elongation as per ASTM 638, and flexural modulus of about 200,000 psi (1,370 MPa) as per ASTM D6790.

The present invention is not limited to the thermoplastic high density polyethylene grades sighted. Rather, the exemplary HDPE described herein are for illustrations purposes only, and not limitation, to show that HDPE resins that have relatively low stress crack resistance can be used to generate high performance cross-linked pipe when formed using the present invention. Another exemplary embodiment may comprise utilizing a higher stress crack resistant thermoplastic HDPE. The point is that the exemplary HDPE's set forth herein are not required to attain a cross-linked HDPE corrugated pipe having superior stress crack resistance and its associated service life.

The grinding or pulverizing of polyethylene into a powder is typically done to allow thermoplastic polyethylene to be rotationally molded. This invention discloses that utilizing grinding or pulverizing of cross-linked corrugated HDPE pipe provides the physical form (a fine powder) that can be recycled. This grinding is sometimes done under cryogenic conditions to make the polymer more friable during the grinding and to reduce particle size and orientation of the powder. In one exemplary embodiment of the present invention, the invention comprises adding from about 2 percent to about 20 percent, more particularly from about 2 to about 6 percent, of isotropic recycle cross-linked powder to the curable thermoplastic base HDPE to act as an inert filler. For the purposes of this disclosure, isotropic powder refers to powder having particles with an average aspect ratio from about 1.0 to about 2.0. This qualification limits the reinforcement capability of the cross-linked polyethylene powder and allows the cross-linked powder to act as inert filler. For the purposes of this disclosure, inert filler refers to recycle cross-linked HDPE powder whose addition changes the stiffness and the flexural modulus in the range from about 0 percent to about 8 percent.

The recycle isotropic cross-linked powder is mixed with the base thermoplastic HDPE and master batch composed of curing agent, catalyst and polyethylene carrier. In other words, the pulverized cross-linked high density polyethylene powder is added as filler during the extrusion of thermoplastic polyethylene pipe. Specifically the cross-linked polyethylene has an average particle size from about 1 to about 450 microns. In one particular exemplary embodiment, the average size is from about 35 to about 200 microns. The percentage of pulverized recycled cross-linked polyethylene is limited to from about 2 to about 20 percent of the pipe composition. The preferred percentage is from about 3 to about 6 percent.

Some of the exemplary embodiments of the present invention may employ silane curing systems that may include, but are not limited to a Dow Corning single step Monsil® method and a two step Sioplas® method. Other exemplary methods that the method of the present invention may use singularly or in combination with other steps described herein may include, but are also not limited to, PolyOne Syncure™, Noveon TempRite®, and Brugg Kabel AG but the invention is not limited to these silane moisture curing systems.

Having described the invention in detail, those skilled in the art will appreciate that, given the present disclosure; modifications may be made to the invention without departing from the spirit of the inventive concept herein described. Therefore, it is not intended that the scope of the invention be limited to the specific and preferred embodiments' illustrations as described. Rather, it is intended that the scope of the invention be determined by the appended claims.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A single or dual wall corrugated HDPE pipe comprising a cross-linked HDPE that is a result of moisture activated silane reaction of a preprocessed extruded and thermoformed thermoplastic high density polyethylene.

2. The corrugated pipe according to claim 1, wherein the thermoplastic HDPE that is cross-linked is HDPE resin having Ml of about 0.1 to about 0.5 grams per 10 minutes and specific gravity of about 0.945 to about 0.960.

3. The corrugated pipe according to claim 1, wherein the corrugated HDPE pipe is composed of recycled cross-linked HDPE isotropic powder filler content of about 2 to about 15 percent that exhibits flexural modulus and stiffness that is within about 2 to about 8 percent as the product without the cross-linked powder.

4. The corrugated pipe according to claim 1, wherein the blow molding grade having an Ml of about 0.55 grams per 10 minutes and a specific gravity of about 0.955.

5. The corrugated pipe according to claim 1, wherein colorant is about 1 to about 6 percent carbon black.

6. The corrugated pipe according to claim 1, wherein the method of producing the cross-linked HDPE corrugated single wall or dual wall pipe comprises utilizing a silane processing method wherein the silane grafted HDPE is combined with its catalyst during pipe extrusion and then after the extrusion and thermoforming the pipe is exposed to water, the water diffuses into the pipe and hydrolyzes the silane to produce a silanol, the silanol then condenses under the action of the catalyst to form intermolecular Si—O—Si cross-links, and the resulting irreversible Si—O—Si cross-linking creates the network structure that gives pipe enhanced dimensional stability, stiffness, stress crack and creep resistance compared to linear HDPE.

7. The corrugated pipe according to claim 1, wherein about 2 to about 15 percent of the polyethylene composition is recycled cross-linked polyethylene added as an inert filler that has a stiffness and flexural modulus within about 8 percent of the product without cross-linked recycled powder content.

8. The corrugated pipe according to claim 7, wherein the cross-linked powder particles have an average aspect ratio between about 1.0 and about 2.0.

9. The corrugated pipe according to claim 7, wherein the cross-linked powder particles have an average particle size between about 1 and about 450 microns.

10. A method of reintroducing finely ground isotropic product recycle into a polymer melt forming process for linear and cross-linked polyethylene products.

11 The method according to claim 10, wherein the polymer melt forming process is injection molding, transfer molding, compression molding and extruding.

12. The method according to claim 10, wherein the finely ground cross-linked polyethylene has an average particle size of about an aspect ratio between 1.0 and 2.0.

13. The method according to claim 10, wherein the finely ground cross-linked polyethylene has an average particle size of about 1 to 450 microns.

14. A Method reintroducing ground or pulverized isotropic recycle cross-linked polyethylene into a melt forming process as inert filler that results in a product composed of a cross-linked polyethylene.

15. The method according to claim 14, wherein the melt forming processes is injection molding, transfer molding, compression molding or extrusion.
